(19) United States
(12) Patent Application Publication
(10) Pub. No.: US 2024/0357387 A1
(43) Pub. Date: Oct. 24, 2024

(54) SYSTEM AND METHOD FOR TESTING A REAL TIME APPLICATION FOR SYNCHRONIZED USER EQUIPMENT

(71) Applicant: Rohde & Schwarz GmbH & Co. KG, Munich (DE)

(72) Inventors: Daniela RADDINO, Munich (DE); Sandra MERKEL, Munich (DE)

(73) Assignee: Rohde & Schwarz GmbH & Co. KG, Munich (DE)

(21) Appl. No.: 18/304,395

(22) Filed: Apr. 21, 2023

(51) Int. Cl. H04W 24/06

(52) U.S. Cl. CPC H04W 24/06

(57) ABSTRACT

A system for testing a real time application for synchronized user equipment is provided. The system comprises a first UE and a second UE. The first UE and the second UE are configured to exchange information as part of executing the real time application. The system further comprises a network simulator. The network simulator is configured to test, if the first UE and the second UE exchange and/or process the information according to a latency requirement. The information is exchanged between the first UE and the second UE by means of uplink communication, downlink communication, and/or sidelink communication.

### FIELD OF THE INVENTION

The present disclosure relates to wireless communication testing, in particular if communication among different wireless devices meets a latency requirement when executing a real time application. The present disclosure thus provides a system and a method for testing a real time application for synchronized user equipment (UE).

### TECHNICAL BACKGROUND

In a real time application, such as a metaverse application, a virtual reality (VR) application or an augmented reality (AR) application, a user may use different wireless devices that need to be synchronized. These wireless devices can include glasses, controllers (e.g., a keyboard, a joystick, a VR controller, an AR controller), or a mobile phone. When executing the real time application, these wireless devices are typically coordinated and controlled by a server. To this end, the wireless devices can be end-to-end connected over a wireless cellular link.

To ensure that the wireless devices are synchronized and exchange and process information according to a predefined latency requirement, the user wants to test communication of the wireless devices.

According to conventional solutions, this requires separate testing of single wireless devices, which is a costly and cumbersome process.

### SUMMARY OF THE INVENTION

Against this background, the object of the present disclosure is to provide a solution for testing a real time application for synchronized UE.

The present disclosure in particular allows for common testing of multiple devices for synchronized data exchange, as it provides a test system and method which can receive different sources of information, send corresponding downlink information, check if these responses are synchronized.

The invention is set out in the appended set of claims. The object is solved by the features of the independent claims. The dependent claims contain further developments.

A first aspect of the present disclosure provides a system for testing a real time application for synchronized user equipment, UE, wherein the system comprises a first UE and a second UE, configured to exchange information as part of executing the real time application; a network simulator, configured to test, if the first UE and the second UE exchange and/or process the information according to a latency requirement; wherein the information is exchanged between the first UE and the second UE by means of at least one of: uplink communication; downlink communication; sidelink communication.

This ensures that in a system in which several UEs interact during execution of a real time application, it can measured if the UEs interact in a synchronized manner and the real time application can be executed without undesired interrupts or disturbances.

In particular, the real time application is executed by the first UE, the second UE, and the network simulator. That is, the real time application can be a distributed application.

In particular, the latency requirement comprises at least one of: checking, if an uplink transmission of the first UE is synchronized with a downlink transmission of the second UE; checking, if a downlink transmission of the first UE is synchronized with an uplink transmission of the second UE; checking, if an outgoing sidelink transmission of the first UE is synchronized with an incoming sidelink transmission of the second UE; checking, if an incoming sidelink transmission of the first UE is synchronized with an outgoing sidelink transmission of the second UE.

In particular, synchronized means that a downlink transmission is received and/or processed at a UE within a predefined time threshold after it was sent as an uplink transmission at a corresponding UE. In particular, synchronized means that an incoming sidelink transmission is received and/or processed at a UE within a predefined time threshold after it was sent as an outgoing sidelink transmission at a corresponding UE.

In particular, processing of the first UE and the second UE is synchronized, if the information is exchanged and/or processed according to the latency requirement.

In particular, the network simulator is further configured to emulate a server as part of executing the synchronized UE real time application. The server e.g. can be a cloud gaming server, a metaverse server, a VR server, or an AR server. The server in particular can be an over-the-top server.

In particular, the system is configured to exchange the information in a wireless manner, e.g. a cellular technology. In particular, the information is exchanged according to a wireless 3GPP standard, such as at least one of: GSM; UTMS; LTW; 5G; 5G NR; 6G; Bluetooth.

In particular, the information comprises at least one of: a control command; audio information; video information; position information; movement information; temperature information; an environmental condition.

In particular, the control command is for controlling a UE.

In particular, the network simulator enables the first UE and the second UE to exchange the information by means of at least one of: uplink communication; downlink communication; sidelink communication.

In particular, the information comprises a command for controlling a UE of the first or second UE that receives the information.

In particular, the information is exchanged among the first UE and the second UE by means of sidelink communication, exclusively.

In particular, the real time application for synchronized UE comprises at least one of: a virtual reality (VR) application; an augmented reality (AR) application; a metaverse application; an application for which a user has different devices that need to be synchronized.

In particular, an AR is a simulated experience that can be similar to or completely different from a real world. In particular, an AR combines aspects of digital and physical worlds. In particular, a metaverse (which can also be called cyberspace) includes a VR, an AR and a virtual world.

In particular, a UE comprises at least one of: a mobile phone; a smartphone; a control device; a left hand control device; a right hand control device; a control device for a smartphone; a left hand control device for a smartphone; a right hand control device for a smartphone; smart glasses. In particular, any of the control devices may comprise at least one of: a joystick; a keyboard; a virtual reality, VR, controller. In particular, a UE can comprise a sensor with a wireless interface and/or an actuator with a wireless interface.

In an implementation form of the first aspect, the first UE and the second UE are configured to exchange the information by using at least one of: a protocol layer; an application layer.

Thereby, the system can measure if the latency requirement is met in particular when information is exchanged by using a protocol layer or an application layer.

In a further implementation form of the first aspect, the first UE and the second UE are configured to exchange the information in real time.

Thereby, the system can measure if the latency requirement is met in particular in a real time environment.

In particular, the term real time characterizes the operation of information technology systems that can reliably deliver certain results within a predetermined period of time, for example in a fixed time frame.

In a further implementation form of the first aspect, the first UE and the second UE are configured to exchange the information exclusively using a data channel.

In particular, the data channel comprises a data bearer. In particular, the information is exchanged without using a control channel.

This is beneficial as the user equipments are agnostic of the test being performed, as only regular data is exchanged and no further control information is required, based on which the UEs could detect that the test is being performed or could be influenced.

In a further implementation form of the first aspect, the first UE or the second UE is further configured to provide an output to a user, based on the exchanged information.

This ensures that the system may test real time applications in which user interaction has to be provided within certain time frames.

In particular, the output comprises at least one of: visual output, haptic output, audio output.

In a further implementation form of the first aspect, the network simulator is further configured to test, if an input at the first UE is correctly reflected at the second UE.

This ensures that the system may test if the real time requirement is not only met with regard to information transmission, but also with regard to correctly performing a predefined action at the target UE, based on the information exchanged.

In particular, the network simulator can test, if an input at the first UE is correctly reflected at the second UE within the boundaries of the latency requirement.

In a further implementation form of the first aspect, the network simulator is further configured to emulate a base station, the first UE and/or the second UE are configured to exchange information with the emulated base station as part of executing the real time application; and wherein the network simulator is further configured to test, if the first UE and/or the second UE exchange the information with the emulated base station according to the latency requirement.

This provides a system which may not only test based on information exchanged among UEs, but also based on information exchanged among a base station and a UE.

In particular, the information is exchanged between the first UE and the emulated base station by means of at least one of: uplink communication, downlink communication.

In particular, the information is exchanged between the second UE and the emulated base station by means of at least one of: uplink communication, downlink communication.

In particular, the information is exchanged between the first UE and the second UE by means of sidelink communication.

A second aspect of the present disclosure provides a method for testing a real time application for synchronized user equipment, UE, wherein the method comprises the steps of exchanging, between a first UE and a second UE, information as part of executing the real time application; testing, by a network simulator, if the first UE and the second UE exchange and/or process the information according to a latency requirement; wherein the information is exchanged between the first UE and the second UE by means of at least one of: uplink communication, downlink communication, sidelink communication.

In an implementation form of the second aspect, the first UE and the second UE are exchanging the information on at least one of: a protocol layer, an application layer

In a further implementation form of the second aspect, the first UE and the second UE are exchanging the information in real time.

In a further implementation form of the second aspect, the first UE and the second UE are exchanging the information exclusively using a data channel.

In a further implementation form of the second aspect, the method further comprises the step of providing, by the first UE or the second UE, an output to a user, based on the exchanged information.

In a further implementation form of the second aspect, the method further comprises the step of testing, by the network simulator, if an input at the first UE is correctly reflected at the second UE.

In a further implementation form of the second aspect, the method further comprises the steps of emulating, by the network simulator, a base station; exchanging, by the first UE and/or the second UE, information with the emulated base station as part of executing the real time application; and testing, by the network simulator, if the first UE and/or the second UE exchange the information with the emulated base station according to the latency requirement.

The second aspect and its implementation forms include the same advantages as the first aspect and its respective implementation forms.

A third aspect of the present disclosure provides a computer program comprising instructions which, when the program is executed by a computer, cause the computer to carry out the method according to the second aspect or any of its implementation forms.

The third aspect and its implementation forms include the same advantages as the first aspect and its respective implementation forms.

An exemplary embodiment of the invention is now further explained with respect to the drawings by way of examples only, in which

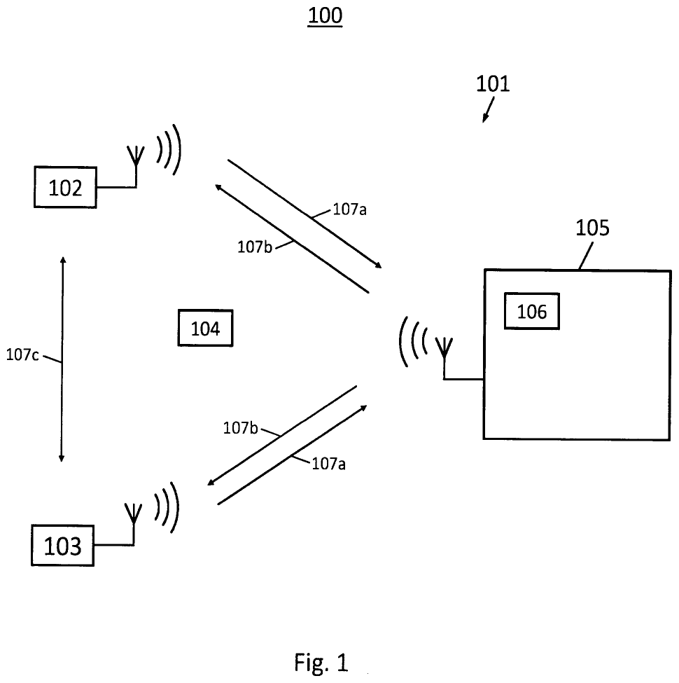

FIG. 1 shows a schematic view of a system according to an embodiment of the present disclosure;

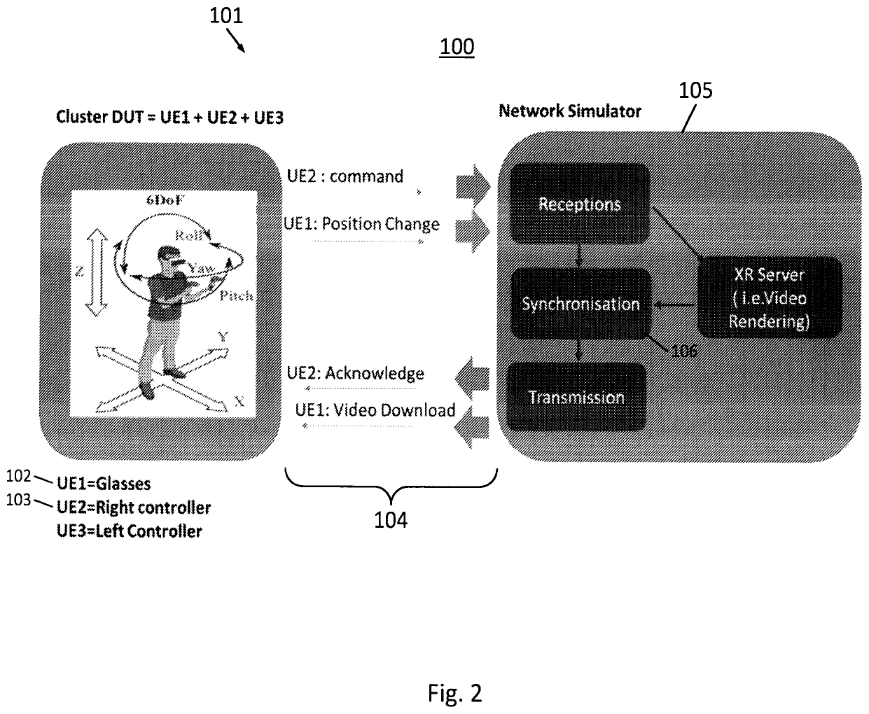

FIG. 2 shows a schematic view of an operating scenario according to the present disclosure;

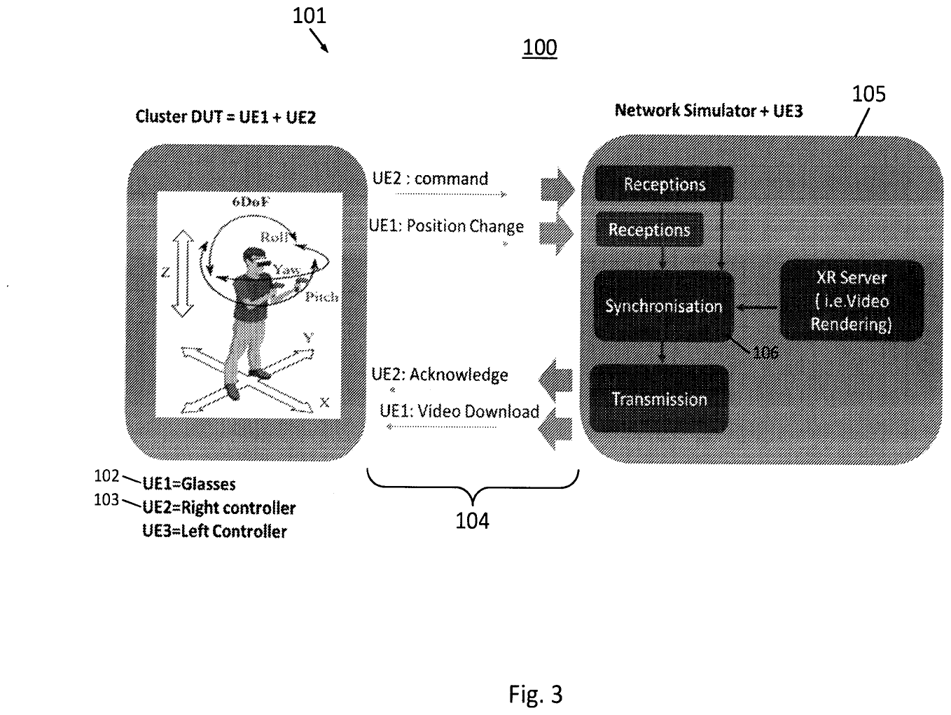

FIG. 3 shows a schematic view of another operating scenario according to the present disclosure; and

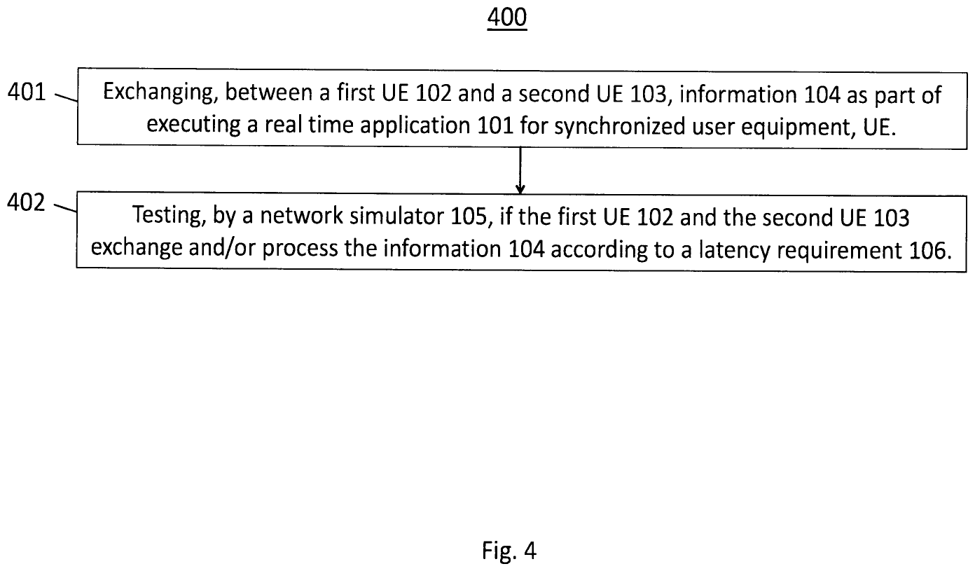

FIG. 4 shows a schematic view of a method according to an embodiment of the present disclosure.

### DETAILED DESCRIPTION

FIG. 1 shows a schematic illustration of a system 100. The system 100 is for testing a real time application 101 for synchronized user equipment, UE. That is, during executing the real time application 101 it is tested, whether UEs, which are involved in performing the application 101 are synchronized.

As illustrated, the system 100 comprises a first UE 102 and a second UE 103. The UEs are configured to exchange information 104 as part of executing the real time application 101. The system further comprises a network simulator 105 that can test, if the first UE 102 and the second UE 103 exchange and/or process the information 104 according to a latency requirement 106.

The information 104 is e.g., exchanged between the first UE 102 and the second UE 103 by means of uplink communication 107a, downlink communication 107b, and/or sidelink communication 107c. These means of communication are typically provided when using a cellular communication link.

The information 104 may include position information and/or movement information. The position information may indicate a geographical position of a UE. The movement information may indicate a movement direction of a UE (e.g. horizontal X/Y, vertical Z). The information 104 may further include control information and/or real time data (e.g., video streaming).

Optionally, the first UE 102 and the second UE 103 can exchange the information 104 by using a protocol layer and/or an application layer.

Executing the real time application 101 in particular includes that the first UE 102 and the second UE 103 exchange the information 104 in real time.

The first UE 102 and the second UE 103 are in particular may exchange the information 104 exclusively using a data channel (and not a control channel).

The first UE 102 or the second UE 103 may provide an output to a user, based on the exchanged information 104.

The network simulator 105 optionally can test if an input at the first UE 102 is correctly reflected at the second UE 103. In other words, the network simulator 105 can check if the second UE 103 reacts to a command of the first UE 102 in a desired manner during a predefined time threshold.

Optionally, the network simulator 105 may emulate a base station. The first UE 102 and/or the second UE 103 can exchange information with the emulated base station as part of executing the real time application 101. The network simulator 105 then can test, if the first UE 102 and/or the second UE 103 exchange the information 104 with the emulated base station according to the latency requirement 106.

FIG. 2 schematically shows an operating scenario of the system 100. In the system 100 of FIG. 2, the first UE 102, the second UE 103 and a third UE exchange information 104 as part of executing the real time application 101. For example, the first UE 102 indicates a position change and receives a video download as a response. The second UE 103 issues a command and receives an acknowledgement as a response. Also the third UE may indicate a position change (not shown) and receive a video download as a response.

In these cases, the network simulator 105 can test, if the first UE (102) receives the video download in time after indicating the position change (that is, according to the latency requirement 106).

The network simulator 105 can also test if the second UE 103 receives the acknowledgement in time, or if the third UE received the video download in time (that is, according to the latency requirement 106).

When a first, second and third UE are tested during execution the real time application 101, these three UEs can also be called cluster device under test (cluster DUT).

With the system 100, it can be tested if the involved UEs can send different sources of information and receive corresponding responses in a synchronized manner. For example, it can be tested if a downlink transmission of a video scene to VR glasses is in synchronization with uplink transmission of a control message of a controller. It can be tested, if uplink transmission of a head position is synchronized with downlink transmission of a new video focus scene, or if downlink of a video transmission is synchronized with uplink of a hand position information. Several devices, which are E2E connected over wireless cellular links to a metaverse, VR or AR server, can be tested.

In other words, the system can connect via different wireless links to several devices, receive and transmit on different links, can test if the contents received and sent acknowledge information are synchronized, predict actions upon the received information and perform a link update.

The cluster DUT can contains one or more UEs, each connected to a wireless cellular network. Any one of the UEs can be a sensor and/or an actuator with an air interface wireless connection. Multiple UEs can be connected to each other (for example wired, or wireless via uplink, downlink, sidelink or bluetooth).

The system 100 as it is shown in FIG. 2, e.g. can emulate a 5GC or a gNB and support an interface to a cluster DUT to guarantee the synchronization of downlink and uplink messages within the cluster DUT and the network components of the network simulator (e.g., a 5G Stack and an VR or AR external server).

In the operating scenario that is schematically shown in FIG. 3, the system 100 emulates a 5GC or a gNB plus one or more UEs (e.g. the third UE) and can guarantee synchronization of messages between the cluster DUT and network components, the 5G Stack and a VR or AR external server.

FIG. 4 shows a method 400 for testing a real time application 101 for synchronized user equipment, UE. The method comprises the steps of exchanging 401, between a first UE 102 and a second UE 103, information 104 as part of executing the real time application 101. The method comprises a further step of testing 402, by a network simulator 105, if the first UE 102 and the second UE 103 exchange and/or process the information 104 according to a latency requirement 106. The information 104 is exchanged between the first UE 102 and the second UE 103 by means of at least one of: uplink communication 107a, downlink communication 107b, sidelink communication 107c.

It is important to note that the inventive device and method very closely correspond. Therefore, all the above said regarding the device is also applicable to the method. Everything which is described in the description and/or claimed in the claims and/or drawn in the drawings can be combined.

The invention is not limited to the illustrated embodiment. The network devices may be mobile terminals such as mobile phones, but also computers such as personal computers or the like. All features described above, or features shown in the figures can be combined with each other in any advantageous manner within the scope of the invention.

1. A system for testing a real time application for synchronized user equipment, UE, wherein the system comprises:
a first UE and a second UE, configured to exchange information as part of executing the real time application;
a network simulator, configured to test, if the first UE and the second UE exchange and/or process the information according to a latency requirement;
wherein the information is exchanged between the first UE and the second UE by means of at least one of: uplink communication; downlink communication; sidelink communication.

2. The system according to claim 1, wherein the first UE and the second UE are configured to exchange the information by using at least one of: a protocol layer; an application layer.

3. The system according to claim 1, wherein the first UE and the second UE are configured to exchange the information in real time.

4. The system according to claim 1, wherein the first UE and the second UE are configured to exchange the information exclusively using a data channel.

5. The system according to claim 1, wherein the first UE or the second UE is further configured to provide an output to a user, based on the exchanged information.

6. The system according to claim 1, wherein the network simulator is further configured to test if an input at the first UE is correctly reflected at the second UE.

7. The system according to claim 1, wherein the network simulator is further configured to emulate a base station; wherein the first UE and/or the second UE are configured to exchange information with the emulated base station as part of executing the real time application; and wherein the network simulator is further configured to test, if the first UE and/or the second UE exchange the information with the emulated base station according to the latency requirement.

8. A method for testing a real time application for synchronized user equipment, UE, wherein the method comprises the steps of:
exchanging, between a first UE and a second UE, information as part of executing the real time application;
testing, by a network simulator, if the first UE and the second UE exchange and/or process the information according to a latency requirement;
wherein the information is exchanged between the first UE and the second UE by means of at least one of: uplink communication, downlink communication, sidelink communication.

9. The method according to claim 8, wherein the first UE and the second UE are exchanging the information on at least one of: a protocol layer, an application layer.

10. The method according to claim 8, wherein the first UE and the second UE are exchanging the information in real time.

11. The method according to claim 8, wherein the first UE and the second UE are exchanging the information exclusively using a data channel.

12. The method according to claim 8, further comprising the step of providing, by the first UE or the second UE, an output to a user, based on the exchanged information.

13. The method according to claim 8, further comprising the step of testing, by the network simulator, if an input at the first UE is correctly reflected at the second UE.

14. The method according to claim 8, further comprising the steps of:
emulating, by the network simulator, a base station;
exchanging, by the first UE and/or the second UE, information with the emulated base station as part of executing the real time application; and
testing, by the network simulator, if the first UE and/or the second UE exchange the information with the emulated base station according to the latency requirement.

15. A computer program comprising instructions which, when the program is executed by a computer, cause the computer to carry out the method according to claim 7.
